(19) United States
(12) Patent Application Publication
(10) Pub. No.: US 2018/0213407 A1
(43) Pub. Date: Jul. 26, 2018

(54) SPECTRUM SHARING METHOD AND DEVICE

(71) Applicant: ZTE CORPORATION, Shenzhen, Guangdong (CN)

(72) Inventors: Ting MIAO, Shenzhen, Guangdong (CN); Xing LIU, Shenzhen, Guangdong (CN); Guanghui YU, Shenzhen, Guangdong (CN); Feng BI, Shenzhen, Guangdong (CN)

(21) Appl. No.: 15/742,594

(22) PCT Filed: May 9, 2016
(86) PCT No.: PCT/CN2016/081430

§ 371 Date: Jan. 8, 2018

(30) Foreign Application Priority Data
Jul. 8, 2015 (CN) 201510399165.5

(51) Int. Cl. H04W 16/14; H04W 28/18; H04W 74/08; H04W 16/10

(52) U.S. Cl. CPC H04W 16/14; H04W 28/18; H04W 72/0453; H04W 16/10; H04W 74/0808

(57) ABSTRACT

The present application discloses a method and a device for spectrum sharing. The method includes: receiving, by a spectrum allocation management node, a spectrum allocation parameter request message sent from a communication station, and performing a spectrum allocation decision according to the spectrum allocation parameter request message, the spectrum allocation parameter request message includes one or more of the following pieces of information: a spectrum sharing mode supported by the communication station, attribute of the communication station, and spectrum attribute requirement of the communication station; and sending, by the spectrum allocation management node, a spectrum allocation parameter response message to the communication station.

### TECHNICAL FIELD

This application relates to wireless communication technologies, and in particular, a spectrum sharing method and device.

### BACKGROUND

With continuous advancements in radio technology, a great variety of radio services emerge, while the spectrum resources on which the radio services rely are limited. On one hand, spectrum resources are in a situation of extreme tension due to users' ever-increasing demand for bandwidth, while on the other hand, the utilization rate of spectrum resources is not high in a traditional fixed spectrum allocation mode. In a sense, the spectrum allocation scheme fixedly allocating spectrum resources to licensed systems has caused the extreme tension for spectrum resources.

To improve the spectrum utilization rate, the traditional fixed spectrum allocation scheme needs to be broken through, so that a spectrum can be allocated dynamically across systems. Spectrum sharing is an effective way to improve the spectrum utilization rate. Currently, various spectrum sharing modes have been proposed, typical examples of which include: Licensed Shared Access (LSA), Licensed-Assisted Access (LAA), secondary level shared access, spectrum sharing within a mobile communication system, Co-Primary shared access, light licensing, Unlicensed Shared Access, and Unlicensed Primary Shared Access, etc. These spectrum sharing modes are introduced briefly below.

1) The LSA gives a method of sharing a LSA spectrum resource between a LSA licensed system and a LSA secondary system under a regulatory framework. The LSA licensed system refers to an actual licensed user of the LSA spectrum resource, that is, an actual owner of the spectrum resource. The LSA secondary system refers to a user who is licensed by a regulatory authority and can share the LSA spectrum resource with the LSA licensed system. However, such licensing merely indicates that the LSA secondary system can use the LSA spectrum resource conditionally, and the actual owner of the LSA spectrum resource is still the LSA licensed system.

2) The LAA refers to a Long Term Evolution (LTE) system operating in an unlicensed spectral band. Typically, the LTE system uses a 5 GHz band at which a Wireless Local Area Network (WLAN) operates. It is found though tests that the LAA in the 5 GHz spectral range can enable a download speed of cellular data to reach 1.6 times the 802.11n standard.

3) In the secondary level shared access, a secondary system uses an idle spectrum resource of a primary system without interfering with the primary system. When the secondary system causes interference with the primary system or the primary system re-occupies the spectrum resource, the secondary system must exit the spectrum of the primary system being used. The secondary system may obtain information on the idle spectrum of the primary system by accessing a geographic location database, or may obtain the idle spectrum of the primary system by spectrum sensing. The idle spectrum depends on the occupancy of spectrum by the primary system, and it is difficult to guarantee the quality of service of the idle spectrum, since the idle spectrum may be used by multiple secondary systems at the same time. A typical secondary system may be, for example, a mobile communication system, and a typical primary system may be, for example, a broadcasting and television system.

4) Spectrum sharing within a mobile communication system may adjust the spectrum of a cell according to network load or other factors to provide more spectrum resources to cells with higher load, thus improving the spectrum utilization rate. A typical spectrum sharing within a mobile communication system may be, for example, spectrum refarming.

5) The Co-Primary shared access means that primary systems use a certain range of spectrum together. Each of the primary systems agrees to use a certain range of spectrum completely equally between the primary systems.

6) The light licensing is a spectrum access model that does not require exclusive licensing. It simplifies licensing process. In light licensing, various systems are deployed coordinately, and a system to be deployed needs to consider its impact on the current deployed system. A typical light licensing may be, for example, UK wireless broadband access at 5.8 GHz.

7) The unauthorized shared access allows for use by multiple system users. In unauthorized shared access, the systems are equal and there is no explicit licensing system. A typically range of spectrum may be, for example, the Industrial Scientific Medical (ISM) band of 2.4 GHz.

8) The unlicensed primary shared access uses no license, and only technologies are licensed. That is, any user who utilizes an allowed technology can use the spectrum, following a principle of sharing among users. A typical example is Digital Enhanced Cordless Telecommunications (DECT) operating at 1800-1900 MHz, DECT devices follow spectrum sharing rules to avoid interference with each other.

The network performances provided by above spectrum sharing modes, as well as requirements for capability of communication stations, are different. Future networks are required to support various services such as mobile communications, Internet of Things, telemedicine, etc. Aspects of air interface designing, architecture designing, and spectrum used are mainly considered in implementations to design a unified, converged network. However, the spectrum management method adopted for network designing is also an important dimension. In some implementations, a communication station is limited to a certain spectrum sharing mode, that is, it is limited to a certain spectrum using rule. However, types of services provided by communication stations in future networks are diversified, and requirements for quality of service vary greatly, for example, different services have different requirements for transmission rate, delay and reliability, data transmission rate is more emphasized for video transmission, lower latency is generally required by voice calls, and ultra-low latency, ultra-high rate and reliability are required by remote surgery. A single spectrum using rule may not meet all the service requirements of a communication station. When a certain requirement of the communication station is not supported by its spectrum usage rule, the communication station would not work properly, resulting in spectrum allocation failures and spectrum resources wastes, which is inconsistent with the original intention of increasing spectrum utilization rate through spectrum sharing.

### SUMMARY

The following is a summary of subject matter described in detail herein. This summary is not intended to limit the scope of the present disclosure.

Example Embodiments of the present disclosure provide a method and a device for spectrum sharing. The technical solutions of example embodiments of this disclosure address a problem of spectrum allocation failures and waste of spectrum resources resulting from the fact that a single spectrum usage rule cannot meet service requirements of a communication station, thereby improving spectrum utilization rate and success rate for spectrum allocation.

An example embodiment of the present disclosure provides a spectrum sharing method, including: receiving, by a spectrum allocation management node, a spectrum allocation parameter request message sent from a communication station, and making a spectrum allocation decision according to the spectrum allocation parameter request message, and the spectrum allocation parameter request message includes at least one of the following pieces of information: a spectrum sharing mode supported by the communication station, an attribute of the communication station, and a spectrum attribute requirement of the communication station; and sending, by the spectrum allocation management node, a spectrum allocation parameter response message to the communication station.

In some implementations, the method further includes: before receiving, by the spectrum allocation management node, the spectrum allocation parameter request message sent from the communication station, sending, by the spectrum allocation management node, resource management status information to the communication station; the resource management status information includes one or more of the following: a spectrum sharing mode supported by the spectrum allocation and management node, a spectrum band corresponding to the spectrum sharing mode, and a new spectrum allocation parameter corresponding to a current operating spectrum of the communication station.

In some implementations, the spectrum sharing mode supported by the communication station includes one or more of the following: Licensed Shared Access (LSA), Licensed-Assisted Access (LAA), secondary level shared access, spectrum sharing within a mobile communication system, Co-Primary shared access, light licensing, Unlicensed Shared Access and Unlicensed Primary Shared Access.

In some implementations, the attribute of the communication station includes one or more of the following: a supported range of spectrum band, a radio access technology, a frequency point, a bandwidth, an antenna location of the communication station, a device identifier, a device type, a device parameter, a coexistence mode and measurement capability.

In some implementations, the coexistence mode is a coexistence mode between the communication station and other communication stations utilizing a frequency which is adjacent to or the same as that of the communication station, and includes one or more of the following: centralized node control coexistence, distributed negotiation coexistence, mixed coexistence and free competition coexistence.

In some implementations, the measurement capability includes one or more of the following: capability of measuring whether a licensed system is being interfered with and the degree of the interference, spectrum sensing capability, and capability of measuring interference relationship between communication stations.

In some implementations, the spectrum sensing capability includes one or more of the following: identifying a type of a signal occupying the spectrum, a lowest detectable level of signal power, a sensible band range of spectrum, and a sensible bandwidth.

In some implementations, the spectrum attribute requirement of the communication station includes one or more of the following: spectrum quality requirement, spectrum stability requirement, bandwidth requirement, requirement for available time of the spectrum and available regional range of the spectrum.

In some implementations, making, by the spectrum allocation management node, the spectrum allocation decision according to the spectrum allocation parameter request message includes: determining, by the spectrum allocation management node, a spectrum sharing mode to be utilized according to the spectrum attribute requirement of the communication station and the spectrum sharing mode supported by the communication station; obtaining, by the spectrum allocation management node, an idle spectrum related information according to the spectrum sharing mode to be utilized and the attribute of the communication station; and determining, by the spectrum allocation management node, a spectrum allocation parameter response message according to the attribute of the communication station, the idle spectrum related information and the spectrum attribute requirement of the communication station.

In some implementations, obtaining the idle spectrum related information includes obtaining the idle spectrum related information from a database, the database includes at least one of the following: a LSA database, a wireless environment map database and a geographic location database.

In some implementations, the spectrum allocation parameter response message includes one or more of the following pieces of information: an allocated frequency point, a bandwidth, an effective time, a radio access technology, uplink and downlink subframe configuration, maximum interference power allowed at a reference point of a licensed system, maximum transmission power allowed, a spectrum sharing mode corresponding to a spectrum band, a specific requirement corresponding to the spectrum sharing mode and coexistence mode configuration.

In some implementations, the specific requirement corresponding to the spectrum sharing mode includes one or more of the following: a Carrier Sense Multiple Access (CSMA) requirement, a sensing requirement, a requirement for interaction with a database and a coexistence requirement.

In some implementations, the coexistence mode configuration includes a coexistence mode to be utilized by the communication station, and a related node configuration corresponding to the coexistence mode, the related node configuration includes one or more of the following: information of centralized management node, and information of other communication stations that require coexistence negotiation; and the centralized management node is responsible for coexistence among communication stations sharing the spectrum.

In some implementations, the method further includes: after sending, by the spectrum allocation management node, the spectrum allocation parameter response message to the communication station, receiving, by the spectrum allocation management node, a spectrum allocation completion message sent from the communication station.

In some implementations, the spectrum allocation completion message includes one or more of the following: an identifier of the communication station, a spectrum allocation parameter of the communication station, an indication of whether the spectrum allocation is successful; and the spectrum allocation parameter of the communication station includes one or more of the following: an actual transmission power of the communication station, and an interference power generated at a licensed system reference point.

In some implementations, in a case where the spectrum allocation completion message indicates that the spectrum allocation of the communication station is successful, and the spectrum allocation completion message includes the spectrum allocation parameter of the communication station, the spectrum allocation management node updates the spectrum allocation parameter response message to be sent to the communication station, according to the spectrum allocation parameter of the communication station, and stores the updated spectrum allocation parameter response message as an actual spectrum allocation parameter of the communication station.

In some implementations, the spectrum allocation management node receives a spectrum allocation completion message sent from the communication station in a case where the resource management status information contains a new spectrum allocation parameter corresponding to the current operating spectrum of the communication station.

An example embodiment of the present disclosure also provides a spectrum sharing method, including: sending, by a communication station, a spectrum allocation parameter request message to a spectrum allocation management node, the spectrum allocation parameter request message being used by the spectrum allocation management node to make a spectrum allocation decision, the spectrum allocation parameter request message includes one or more of the following pieces of information: a spectrum sharing mode supported by the communication station, an attribute of the communication station, and a spectrum attribute requirement of the communication station; and receiving, by the communication station, a spectrum allocation parameter response message sent by the spectrum allocation management node, and completing spectrum allocation according to the spectrum allocation parameter response message.

In some implementations, the method further includes: before sending, by the communication station, a spectrum allocation parameter request message to the spectrum allocation management node, receiving, by the communication station, resource management status information sent by the spectrum allocation management node; and generating, by the communication station, the spectrum allocation parameter request message or adjusting a spectrum allocation parameter of the current operating spectrum according to the resource management status information.

In some implementations, the spectrum sharing mode supported by the communication station includes one or more of the following: Licensed Shared Access (LSA), Licensed-Assisted Access (LAA), secondary level shared access, spectrum sharing within a mobile communication system, Co-Primary shared access, light licensing, Unlicensed Shared Access and Unlicensed Primary Shared Access.

In some implementations, the attribute of the communication station includes one or more of the following: a supported range of spectrum band, a radio access technology, a frequency point, a bandwidth, an antenna location of the communication station, a device identifier, a device type, a device parameter, a coexistence mode and measurement capability.

In some implementations, the coexistence mode is a coexistence mode between the communication station and other communication stations utilizing a frequency which is adjacent to or the same as that of the communication station, and includes one or more of the following: centralized node control coexistence, distributed negotiation coexistence, mixed coexistence and free competition coexistence.

In some implementations, the measurement capability includes one or more of the following: capability of measuring whether a licensed system is being interfered with and the degree of the interference, spectrum sensing capability, and capability of measuring interference relationship between communication stations.

In some implementations, the spectrum sensing capability includes one or more of the following: identifying a signal type of an occupied spectrum, a lowest detectable level of signal power, a sensible band range of spectrum, and a sensible bandwidth.

In some implementations, the spectrum attribute requirement of the communication station includes one or more of the following: spectrum quality requirement, spectrum stability requirement, bandwidth requirement, requirement for available time of the spectrum and available regional range of the spectrum.

In some implementations, the spectrum stability requirement includes one or more of the following: time stability requirement, space stability requirement, and service quality stability requirement.

In some implementations, the spectrum allocation parameter response message includes one or more of the following pieces of information: an allocated frequency point, a bandwidth, an effective time, a radio access technology, uplink and downlink subframe configuration, maximum interference power allowed at a reference point of a licensed system, maximum transmission power allowed, a spectrum sharing mode corresponding to a spectrum band, a specific requirement corresponding to the spectrum sharing mode and coexistence mode configuration.

In some implementations, the specific requirement corresponding to the spectrum sharing mode includes one or more of the following: a Carrier Sense Multiple Access (CSMA) requirement, a sensing requirement, a requirement for interaction with a database and a coexistence requirement.

In some implementations, the coexistence mode configuration includes a coexistence mode to be utilized by the communication station, and a related node configuration corresponding to the coexistence mode, the related node configuration includes one or more of the following: information of centralized management node, and information of other communication stations that require coexistence negotiation; and the centralized management node is responsible for coexistence among communication stations sharing the spectrum.

In some implementations, completing, by the communication station, spectrum allocation according to the spectrum allocation parameter response message includes: completing, by the communication station, network parameter configuration according to the spectrum allocation parameter, and operating on a newly allocated spectrum resource while meeting a specific requirement corresponding to the spectrum sharing mode.

In some implementations, the method further includes: after completing spectrum allocation, by the communication station, according to the spectrum allocation parameter response message, sending, by the communication station, a spectrum allocation completion message to the spectrum allocation management node.

In some implementations, the spectrum allocation completion message includes one or more of the following: an identifier of the communication station, a spectrum allocation parameter of the communication station, an indication of whether the spectrum allocation is successful; the spectrum allocation parameter of the communication station includes one or more of the following: an actual transmission power of the communication station, and an interference power generated at a licensed system reference point.

In some implementations, in a case where the resource management status information contains a new spectrum allocation parameter corresponding to the current operating spectrum of the communication station, the communication station completes spectrum allocation according to the resource management status information, and sends a spectrum allocation completion message to the spectrum allocation management node.

An example embodiment of the present disclosure also provides a spectrum allocating method, including: sending, by a spectrum allocation management node, resource management status information to a communication station, the resource management status information includes a new spectrum allocation parameter corresponding to a current operating spectrum of the communication station; and receiving, by the spectrum allocation management node, a spectrum allocation completion message sent by the communication station after adjusting a spectrum allocation parameter of the current operating spectrum according to the new spectrum allocation parameter.

An example embodiment of the present disclosure also provides a spectrum allocating method, including: receiving, by a communication station, resource management status information sent from a spectrum allocation management node, the resource management status information includes a new spectrum allocation parameter corresponding to a current operating spectrum of the communication station; and sending, by the communication station, a spectrum allocation completion message to the spectrum allocation management node, after adjusting a spectrum allocation parameter of the current operating spectrum according to the new spectrum allocation parameter.

An example embodiment of the present disclosure also provides a spectrum allocation management node, including: a receiver, configured to receive a spectrum allocation parameter request message sent from a communication station, and perform a spectrum allocation decision according to the spectrum allocation parameter request message, the spectrum allocation parameter request message at least includes one or more of the following pieces of information: a spectrum sharing mode supported by the communication station, an attribute of the communication station, and a spectrum attribute requirement of the communication station; and a transmitter, configured to send a spectrum allocation parameter response message to the communication station.

An example embodiment of the present disclosure also provides a communication station, including: a transmitter, configured to send a spectrum allocation parameter request message to a spectrum allocation management node, the spectrum allocation parameter request message is used by the spectrum allocation management node to make a spectrum allocation decision, the spectrum allocation parameter request message at least includes one or more of the following pieces of information: a spectrum sharing mode supported by the communication station, an attribute of the communication station, and a spectrum attribute requirement of the communication station; and a receiver, configured to receive a spectrum allocation parameter response message sent by the spectrum allocation management node, and complete spectrum allocation according to the spectrum allocation parameter response message.

Other aspects will become apparent upon reading and referring to the drawings and detailed description.

### BRIEF DESCRIPTION OF THE DRAWINGS

FIG. 1 is a schematic diagram of architecture of an embodiment of the present disclosure;

FIG. 2 is a schematic flowchart of a spectrum sharing method according to an embodiment of the present disclosure;

FIG. 3 is a schematic flowchart of another spectrum sharing method according to an embodiment of the present disclosure;

FIG. 4 is a schematic flowchart of a first embodiment according to an embodiment of the present disclosure.

FIG. 5 is a schematic flowchart of a second embodiment according to an embodiment of the present disclosure.

FIG. 6 is a schematic flowchart of a third embodiment according to an embodiment of the present disclosure.

FIG. 7 is a schematic flowchart of a fourth embodiment according to an embodiment of the present disclosure.

FIG. 8 is a schematic flowchart of a fifth embodiment according to an embodiment of the present disclosure.

FIG. 9 is a schematic diagram of a structure of a spectrum allocation management node according to an embodiment of the present disclosure;

FIG. 10 is a schematic diagram of a structure of a communication station according to an embodiment of the present disclosure.

### DETAILED DESCRIPTION

Hereinafter, example embodiments of the present disclosure will be described in detail with reference to the accompanying drawings. It should be noted that, example embodiments in the present application and features in the example embodiments may be arbitrarily combined with each other as long as there is no conflicts.

The steps illustrated in the flowcharts of the figures may be performed in computer systems, such as a set of computer-executable instructions. Also, although logical orders are shown in the flowcharts, in some cases, the steps shown or described may be performed in an order different from that herein.

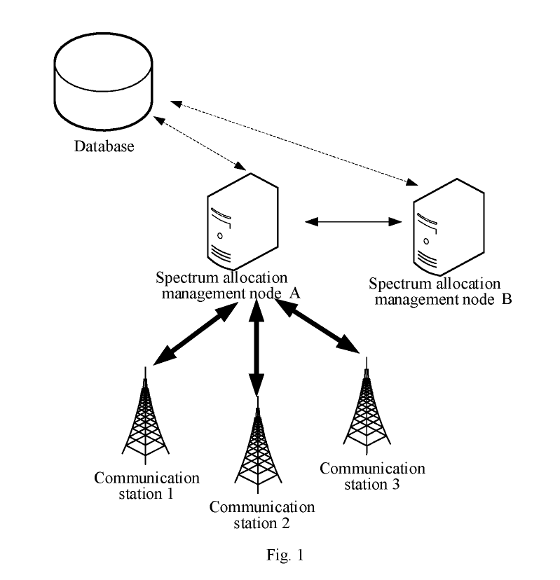

FIG. 1 is a schematic diagram of architecture according to an example embodiment of the present disclosure. The functional entities in the architecture are specifically described below.

A communication station may represent a base station, an access point (AP), or the like in a cellular network system such as 5G LTE-A, LTE, 3G system, 2G and the like, for example, a base station (BS) in a 2G system, a base station (Node B, NB) in a 3G system, an evolved Node B (eNB), a Donor evolved Node B (DeNB), a Home evolved Node B (HeNB), a relay station, a Picocell, a Femtocell and the like, or an access point in an IEEE802 system such as Wireless Local Area Network (WLAN), Wireless Regional Area Network (WRAN), Worldwide Interoperability for Microwave Access (WiMAX) and the like.

A spectrum allocation management node is a functional entity responsible for allocation and management of spectrum resources of a communication station, with an optional function of being responsible for coexistence among communication stations sharing spectrum. The spectrum allocation management node may be any one of the following functional entities: a Central Control Point (CCP), a Spectrum Coordinator (SC), a Multi-RAT Coordinator (MRC), a Reconfiguration Management Node (RMN), a LSA Controller (LC), an Operation Administration and Maintenance (OAM), an Equipment Management System (EMS), a Network Management System (NMS), a Mobility Management Entity (MME), a Serving GateWay (S-GW), a PDN GateWay (P-GW), a Serving GPRS Support Node (SGSN), a Radio Network Controller (RNC) and an Element Management System (EMS).

A database is a functional entity responsible for protecting a licensed system and storing spectrum usage of the licensed system. The database may also store rules for protecting the licensed system from being interfered, and may be responsible for providing available spectrum resources for the communication station or the spectrum allocation management node. The database may include the following functional entities: a LSA database, a wireless environment map database, and a geographic location database, each of these databases generally corresponds to a spectrum sharing mode. For example, when the spectrum allocation management node determines to provide spectrum for the communication station in a LSA mode, the spectrum allocation management node can access the LSA database; when the spectrum allocation management node determines to provide spectrum for the communication station in a secondary level shared access mode, the spectrum allocation management node can access the geographic location database; when the spectrum allocation management node determines to provide spectrum for the communication station in a mode such as spectrum sharing within a mobile communication system, Co-Primary shared access, light licensing, Unlicensed Primary Shared Access, Licensed-Assisted Access (LAA), Unlicensed Shared Access and the like, the spectrum allocation management node can access the wireless environment map database. Provided here are merely some of possible examples, and there are more ways for correspondence between databases and spectrum sharing modes in practical implementations. These databases may be located in one physical entity, and data in the databases may be placed together to form a large database, in which respective data information is retrieved as needed. These databases may also be divided into several groups, and each group is located in a separate physical entity.

It should be noted that the database and the spectrum allocation management node may also be located in one physical entity; additionally, when the spectrum allocation management node is a newly added node, for example, when the spectrum allocation management node is one of CCP, SC, MRC, RMN and LC, the communication station may be directly connected to the spectrum allocation management node or may be connected to the spectrum allocation management node through OAM.

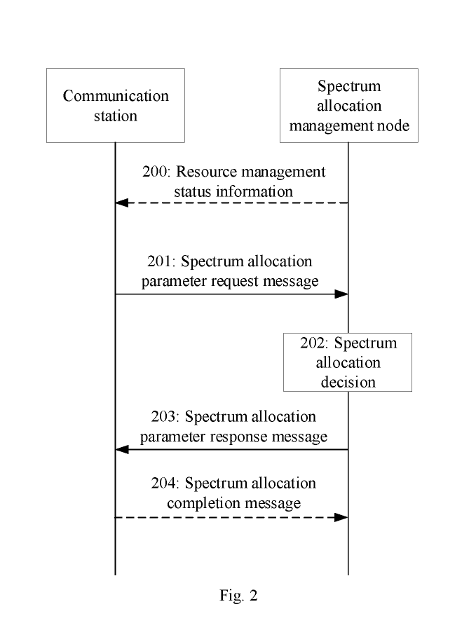

An example embodiment of the present disclosure provides a spectrum sharing method, as shown in FIG. 2, applied at a spectrum allocation management node side, including for example the following steps 200 through 204.

At step 201, the spectrum allocation management node receives a spectrum allocation parameter request message sent from a communication station.

In some implementations, the spectrum allocation parameter request message includes information on at least one or more of the following: a spectrum sharing mode supported by the communication station, an attribute of the communication station, and a spectrum attribute requirement of the communication station.

In some implementations, the method further includes a step 200 before the step 201, at which the spectrum allocation management node sends resource management status information to the communication station.

The resource management status information includes one or more of the following: a spectrum sharing mode supported by the spectrum allocation management node, a spectrum band corresponding to the spectrum sharing mode, and a new spectrum allocation parameter corresponding to a current operating spectrum of the communication station; the new spectrum allocation parameter includes all or part of information in an original spectrum allocation parameter.

In some implementations, the spectrum allocation management node sends the resource management status information to the communication station periodically, and/or sends the resource management status information to the communication station when a triggering event occurs.

The triggering event includes at least one or more of the following events: an event where the communication station initially connects to the spectrum allocation management node, an event where a spectrum allocation for a subordinate communication station of the spectrum allocation management node needs to be changed, an event where the spectrum sharing mode supported by the spectrum allocation management node changes, and an event where a spectrum band corresponding to the spectrum sharing mode changes.

In some implementations, the ways in which the spectrum allocation management node sends the resource management status information to the communication station is not limited, including any one of unicast, multicast, broadcast, or any combination thereof.

In some implementations, the spectrum allocation management node determines the content of the resource management status information according to at least one of of the following: its own capability, configuration by a staff member, and an interference protection principle. The interference protection principle refers to a rule that needs to be followed by communication stations to ensure that communication stations do not interfere with each other.

In some implementations, the spectrum sharing mode supported by the communication station includes one or more of the following: Licensed Shared Access (LSA), Licensed-Assisted Access (LAA), secondary level shared access, spectrum sharing within a mobile communication system, Co-Primary shared access, light licensing, Unlicensed Shared Access and Unlicensed Primary Shared Access.

In some implementations, the attribute of the communication station includes one or more of the following: a supported range of spectrum band, a radio access technology, a frequency point, a bandwidth, an antenna location of the communication station, a device identifier, a device type, a device parameter, a coexistence mode and measurement capability.

The device type is configured to indicate whether a device is a mobile device or a stationary device.

The device parameter includes one or more of the following: an azimuth, a pitch angle, a height, a spectrum emission template, an adjacent channel selectivity, a maximum allowable transmission power, and a minimum allowable transmission power of the antenna.

In some implementations, the coexistence mode is a coexistence mode between the communication station and other communication stations utilizing a carrier frequency which is adjacent to or the same as that of the communication station, and includes one or more of the following: centralized node control coexistence, distributed negotiation coexistence, mixed coexistence and free competition coexistence.

The mixed coexistence refers to clustering of communication stations, with a centralized node being responsible for coexistence among the clusters. Coexistence among intra-cluster communication stations is implemented by distributed negotiation among intra-cluster communication stations or by centralized management by a cluster head.

In some implementations, the measurement capability includes one or more of the following: capability of measuring whether a licensed system is being interfered with and the degree of the interference, spectrum sensing capability, and capability of measuring interference relationship between communication stations.

The spectrum sensing capability refers to capability of a communication station for determining whether a licensed user exists or not by detecting a licensed spectrum band, and thus detecting an available spectrum hole. The spectrum sensing capability includes one or more of the following: identifying a type of a signal occupying the spectrum, the lowest detectable level of signal power, a sensible range of spectrum band, and a sensible bandwidth.

In some implementations, the spectrum attribute requirement of the communication station includes one or more of the following: spectrum quality requirement, spectrum stability requirement, bandwidth requirement, requirement for available time of the spectrum and available regional range of the spectrum.

The spectrum quality requirement refers to a quantity that reflects transmission quality when a communication station performs communication using the spectrum. In an example embodiment of the present disclosure, three methods for describing the spectral quality requirement are given: 1) it is described as a requirement for an interfering power spectral density generated at the communication station (i.e., requirement for interfering power level per Hertz bandwidth) when the spectrum is used by another station; 2) it is described as a requirement for an interfering power generated on a corresponding bandwidth at the communication station when the spectrum is used by another station, the corresponding bandwidth refers to a bandwidth corresponding to the bandwidth requirement of the communication station; 3) it is described as a requirement for a signal-to-interference noise ratio when the communication station is performing communication using the spectrum. Specifically, for example, the spectral quality requirement is that the interfering power spectral density being lower than −80 dBm/Hz or that the interfering power on a 40 MHz bandwidth being lower than −3.98 dBm or that the signal-to-interference noise ratio being greater than 15 dB.

In some implementations, the spectrum quality requirement is used by the spectrum allocation management node or the database to assess whether the quality of an idle spectrum meets the spectrum quality requirement of the communication station. A method for the assessing is as follows: the interfering power spectral density or interfering power generated by another station and observed at the communication station is assessed according to a transmission power of the another station using the spectrum in the vicinity of the communication station and a path loss model of the another station to the communication station, or the signal to interference noise ratio when the spectrum is used by the communication station is estimated according to the maximum transmission power allowed when the spectrum is used by the communication station, and the interfering power generated by another station using the spectrum in the vicinity of the communication station and observed at the communication station, thereby assessing whether the interfering power spectral density or the interfering power or the signal to interference noise ratio meets the spectrum quality requirement of the communication station.

In some implementations, the spectrum stability requirement includes one or more of the following: time stability requirement, space stability requirement, and service quality stability requirement.

At step 202: the spectrum allocation management node performs a spectrum allocation decision according to the spectrum allocation parameter request message.

In some implementations, the step 202 may specifically include: determining, by the spectrum allocation management node, a spectrum sharing mode to be utilized according to the spectrum attribute requirement of the communication station and the spectrum sharing mode supported by the communication station; obtaining, by the spectrum allocation management node, an idle spectrum related information according to the spectrum sharing mode to be utilized and the attribute of the communication station; determining, by the spectrum allocation management node, a spectrum allocation parameter response message according to the attribute of the communication station, the idle spectrum related information and the spectrum attribute requirement of the communication station.

In some implementations, the idle spectrum related information mainly includes a spectrum that is not used by a licensed system at certain time and location. The idle spectrum related information may further include rules for protecting a licensed system from being interfered with.

In some implementations, obtaining the idle spectrum related information includes obtaining the idle spectrum related information from a database, and the database includes at least one of the following: a LSA database, a wireless environment map database and a geographic location database.

At step 203: the spectrum allocation management node sends a spectrum allocation parameter response message to the communication station.

In some implementations, the spectrum allocation parameter response message includes one or more of the following pieces of information: an allocated frequency point, a bandwidth, an effective time, a radio access technology, uplink and downlink subframe configuration, maximum interference power allowed at a reference point of a licensed system, maximum transmission power allowed, a spectrum sharing mode corresponding to a spectrum band, a specific requirement corresponding to the spectrum sharing mode and coexistence mode configuration

In some implementations, the specific requirement corresponding to the spectrum sharing mode includes one or more of the following: a Carrier Sense Multiple Access (CSMA) requirement, a sensing requirement, a requirement for interaction with a database, and a coexistence requirement.

The CSMA requirement includes one or more of the following: non-persistent CSMA, 1-persistent CSMA, p-persistent CSMA, conflict detection CSMA, conflict avoidance CSMA, a CSMA threshold, and the longest duration of using a spectrum continuously.

The sensing requirement includes one or more of the following: a sensing threshold, a sensing period, a sensing duration, a minimum sensing duration, and a licensed system characteristic signal.

The requirement for interaction with a database includes one or more of the following: a maximum time interval for accessing the database, and whether to enable a function of receiving information pushed by the database.

The coexistence requirement includes one or more of the following: a time requirement for exiting a spectrum, a protected area corresponding to the spectrum, a prohibited area corresponding to the spectrum, a restricted area corresponding to the spectrum, interfering tolerance threshold of a licensed system, whether a silent period needs to be configured, and a silent period configuration. The content of the coexistence requirement in an actual implementation depends on the spectrum sharing mode adopted.

The time requirement for exiting a spectrum refers to a limit to a period of time starting from receiving a notification to exit a certain spectrum or discovering that a certain operating spectrum is interfering with a licensed system or leaving a restricted area of a spectrum, and ending at the point when the communication station exits the spectrum completely. For example, IEEE802.22 requires a secondary system to exit a spectrum within two seconds after discovering that a licensed system has re-occupied the spectrum.

The protected area refers to an area in which a licensed system receiver cannot be interfered with.

The prohibited area refers to an area in which a secondary system is not allowed to have an activated radio transmitter.

The restricted area refers to an area in which a secondary system is allowed to use the spectrum under a certain constraint condition.

In some implementations, the coexistence mode configuration includes a coexistence mode to be utilized by the communication station, and a related node configuration corresponding to the coexistence mode, the related node configuration includes one or more of the following: information of centralized management node, and information of other communication stations that require coexistence negotiation.

The centralized management node is responsible for coexistence among communication stations sharing the spectrum. The function of this node may also be implemented in the spectrum allocation management node.

The information of other communication stations includes one or more of the following: a communication station identifier, a frequency point, a bandwidth, a wireless technology, and a maximum tolerable interfering power.

In some implementations, the method further includes a step 204 after the step 203 at which the spectrum allocation management node receives a spectrum allocation completion message sent from the communication station.

In some implementations, the spectrum allocation completion message includes one or more of the following: an identifier of the communication station, a spectrum allocation parameter of the communication station, an indication of whether the spectrum allocation is successful, the spectrum allocation parameter of the communication station includes one or more of the following: an actual transmission power of the communication station, and an interference power generated at a licensed system reference point.

In some implementations, when the spectrum allocation completion message indicates that the spectrum allocation of the communication station is successful, in a case where the spectrum allocation completion message also includes the spectrum allocation parameter of the communication station, the spectrum allocation management node updates the spectrum allocation parameter response message to be sent to the communication station, according to the spectrum allocation parameter of the communication station, and stores the updated spectrum allocation parameter response message as an actual spectrum allocation parameter of the communication station.

In some implementations, the spectrum allocation management node receives a spectrum allocation completion message sent from the communication station, when the resource management status information contains a new spectrum allocation parameter corresponding to the current operating spectrum of the communication station.

It should be noted in the above embodiments that, generally, network performances provided by different spectrum sharing modes are different, and requirements for capabilities of a communication station are also different. Generally, both of Co-Primary shared access and light licensing are modes in which the spectrum is equally shared among licensed operators, and the spectrum is relatively stable in time and space. The spectrum stability is slightly worse in the light licensing mode, since a later accessed system needs to consider its impact on the existing system. However, neither of the two modes can guarantee the number of the spectrums instantaneously accessed by an operator, and the transmission rates provided may rise and fall, and coexistences are implemented among the communication stations through agreements or policy. Since one LSA spectrum band is licensed to only a limited number of LSA secondary systems, and there is a specific sharing principle between the LSA secondary systems and the LSA licensed systems, thus LSA can provide a spectrum relatively stable in time and space, that is, the available time and available geographic area of an available spectrum is relatively fixed, and the quality of service of the LSA secondary system can be guaranteed. The other spectrum sharing modes are all unlicensed spectrum sharing. Except for the secondary level shared access which can obtain a relatively stable idle spectrum from the geographic location database, the unlicensed spectrum sharing provides a spectrum with a relatively poor stability, thus communication stations are generally required to have certain abilities to implement coexistence, and the quality of service provided by the communication station is not guaranteed.

The example embodiment of the present disclosure provides the spectrum sharing method including: receiving, by a spectrum allocation management node, a spectrum allocation parameter request message sent from a communication station, and performing a spectrum allocation decision according to the spectrum allocation parameter request message, the spectrum allocation parameter request message includes at least one or more of the following pieces of information: a spectrum sharing mode supported by the communication station, an attribute of the communication station, and a spectrum attribute requirement of the communication station; sending, by the spectrum allocation management node, a spectrum allocation parameter response message to the communication station. The technical solution of the example embodiment of this disclosure addresses a problem of spectrum allocation failures and waste of spectrum resources resulting from the fact that a single spectrum usage rule cannot meet service requirements of a communication station, thereby improving spectrum utilization rate and success rate for spectrum allocation.

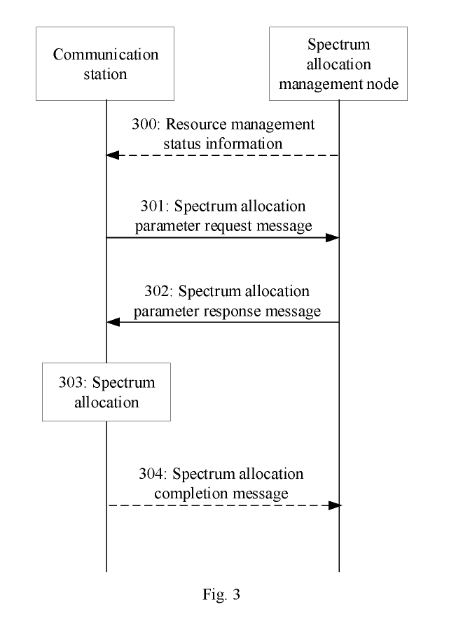

An example embodiment of the present disclosure provides another spectrum sharing method, as shown in FIG. 3. The method is applied to a communication station side, and the method includes for example the following steps 300 through 304.

At step 301, a communication station sends a spectrum allocation parameter request message to a spectrum allocation management node.

In some implementations, the spectrum allocation parameter request message is used by the spectrum allocation management node for performing a spectrum allocation decision, and includes at least one or more of the following pieces of information: a spectrum sharing mode supported by the communication station, an attribute of the communication station, and a spectrum attribute requirement of the communication station.

In some implementations, the method further includes a step 300 before the step 301: receiving, by the communication station, resource management status information sent by the spectrum allocation management node; and generating, by the communication station, the spectrum allocation parameter request message or adjusting a spectrum allocation parameter of the current operating spectrum according to the resource management status information.

In some implementations, the spectrum sharing mode supported by the communication station includes one or more of the following: Licensed Shared Access (LSA), Licensed-Assisted Access (LAA), secondary level shared access, spectrum sharing within a mobile communication system, Co-Primary shared access, light licensing, Unlicensed Shared Access and Unlicensed Primary Shared Access.

In some implementations, the attribute of the communication station includes one or more of the following: a supported range of spectrum band, a radio access technology, a frequency point, a bandwidth, an antenna location of the communication station, a device identifier, a device type, a device parameter, a coexistence mode and measurement capability.

In some implementations, the coexistence mode is a coexistence mode between the communication station and other communication stations utilizing a frequency which is adjacent to or the same as that of the communication station, and includes one or more of the following: centralized node control coexistence, distributed negotiation coexistence, mixed coexistence and free competition coexistence.

The mixed coexistence refers to clustering of communication stations, with a centralized node being responsible for coexistence among the clusters. Coexistence among intra-cluster communication stations is implemented by distributed negotiation among intra-cluster communication stations or by centralized management by a cluster head.

In some implementations, the measurement capability includes one or more of the following: capability of measuring whether a licensed system is being interfered with and the degree of the interference, spectrum sensing capability, and capability of measuring interference relationship between communication stations.

The spectrum sensing capability refers to capability of a communication station of determining whether a licensed user exists or not by detecting a licensed spectrum band, and thus detecting an available spectrum hole. The spectrum sensing capability includes one or more of the following: identifying a type of a signal occupying the spectrum, the lowest detectable level of signal power, a sensible range of spectrum band, and a sensible bandwidth.

In some implementations, the spectrum attribute requirement of the communication station includes one or more of the following: spectrum quality requirement, spectrum stability requirement, bandwidth requirement, requirement for available time of the spectrum and available regional range of the spectrum.

The spectrum quality requirement refers to a quantity that reflects transmission quality when a communication station performs communication using the spectrum. In an example embodiment of the present disclosure, three methods for describing the spectral quality requirement are given: 1) it is described as a requirement for an interfering power spectral density observed at the communication station (i.e., requirement for interfering power level per Hertz bandwidth) when the spectrum is used by another station; 2) it is described as a requirement for an interfering power generated on a corresponding bandwidth observed at the communication station when the spectrum is used by another station, and the corresponding bandwidth refers to a bandwidth corresponding to the bandwidth requirement of the communication station; 3) it is described as a requirement for a signal-to-interference noise ratio when the communication station is performing communication using the spectrum. Specifically, for example, the spectral quality requirement is that the interfering power spectral density being lower than −80 dBm/Hz or that the interfering power on a 40 MHz bandwidth being lower than −3.98 dBm or that the signal-to-interference noise ratio being greater than 15 dB.

In some implementations, the spectrum quality requirement is used by the spectrum allocation management node or the database to assess whether the quality of an idle spectrum meets the spectrum quality requirement of the communication station. A method for the assessing is as follows: the interfering power spectral density or interfering power generated by another station and observed at the communication station is assessed according to a transmission power of the another station using the spectrum in the vicinity of the communication station and a path loss model of the another station to the communication station, or the signal to interference noise ratio is estimated according to the maximum transmission power allowed when the spectrum is used by the communication station, and the interfering power generated at the communication station by another station using the spectrum in the vicinity of the communication station, thereby assessing whether the interfering power spectral density or the interfering power or the signal to interference noise ratio meets the spectrum quality requirement of the communication station.

In some implementations, the spectrum stability requirement includes one or more of the following: time stability requirement, space stability requirement, and service quality stability requirement.

At step 302: the communication station receives the spectrum allocation parameter response message sent by the spectrum allocation management node.

In some implementations, the spectrum allocation parameter response message includes one or more of the following pieces of information: an allocated frequency point, a bandwidth, an effective time, a radio access technology, uplink and downlink subframe configuration, maximum interference power allowed at a reference point of a licensed system, maximum transmission power allowed, a spectrum sharing mode corresponding to a spectrum band, a specific requirement corresponding to the spectrum sharing mode and coexistence mode configuration

In some implementations, the specific requirement corresponding to the spectrum sharing mode includes one or more of the following: a Carrier Sense Multiple Access (CSMA) requirement, a sensing requirement, a requirement for interaction with a database and a coexistence requirement.

The CSMA requirement includes one or more of the following: non-persistent CSMA, 1-persistent CSMA, p-persistent CSMA, conflict detection CSMA, conflict avoidance CSMA, a CSMA threshold, and the longest duration of using a spectrum continuously.

The sensing requirement includes one or more of the following: a sensing threshold, a sensing period, a sensing duration, a minimum sensing duration, and a licensed system characteristic signal.

The requirement for interaction with a database includes one or more of the following: a maximum time interval for accessing the database, and whether to enable a function of receiving information pushed by the database.

The coexistence requirement includes one or more of the following: a time requirement for exiting a spectrum, a protected area corresponding to the spectrum, a prohibited area corresponding to the spectrum, a restricted area corresponding to the spectrum, interfering tolerance threshold of a licensed system, whether a silent period needs to be configured, and a silent period configuration. The content of the coexistence requirement in an actual implementation depends on the spectrum sharing mode adopted.

The time requirement for exiting a spectrum refers to a limit to a period of time starting from receiving a notification to exit a certain spectrum or discovering that a certain operating spectrum is interfering with a licensed system or leaving a restricted area of a spectrum, and ending at the point when the communication station exits the spectrum completely. For example, IEEE802.22 requires a secondary system to exit a spectrum within two seconds after discovering that a licensed system has re-occupied the spectrum.

The protected area refers to an area in which a licensed system receiver cannot be interfered with.

The prohibited area refers to an area in which a secondary system is not allowed to have an activated radio transmitter.

The restricted area refers to an area in which a secondary system is allowed to use the spectrum under a certain constraint condition.

In some implementations, the coexistence mode configuration includes a coexistence mode to be utilized by the communication station, and a related node configuration corresponding to the coexistence mode, and the related node configuration includes one or more of the following: information of centralized management node, and information of other communication stations that require coexistence negotiation.

The centralized management node is responsible for coexistence among communication stations sharing the spectrum. The function of the centralized management node may also be implemented in the spectrum allocation management node.

The information of other communication stations includes one or more of the following: a communication station identifier, a frequency point, a bandwidth, a wireless technology, and a maximum tolerable interfering power.

At step 303: the communication station completes the spectrum allocation according to the spectrum allocation parameter response message.

In some implementations, the step 303 may include: completing, by the communication station, network parameter configuration according to the spectrum allocation parameter, and operating on a newly allocated spectrum resource while meeting a specific requirement corresponding to the spectrum sharing mode.

In some implementations, the method may further include a step 304 after the step 303, at which the communication station sends a spectrum allocation completion message to the spectrum allocation management node.

In some implementations, the spectrum allocation completion message includes one or more of the following: an identifier of the communication station, a spectrum allocation parameter of the communication station, an indication of whether the spectrum allocation is successful, and the spectrum allocation parameter of the communication station includes one or more of the following: an actual transmission power of the communication station, and an interference power generated at a licensed system reference point.

It should be noted that, in the above embodiments, generally, network performances provided by different spectrum sharing modes are different, and requirements for capabilities of a communication station are also different. Generally, both of Co-Primary shared access and light licensing are modes in which spectrum is equally shared among licensed operators, and the spectrum is relatively stable in time and space. The spectrum stability is slightly worse in the light licensing mode, since a later accessed system needs to consider its impact on the existing system. However, neither of the two modes can guarantee the number of the spectrums instantaneously accessed by an operator, and the transmission rates provided may rise and fall, and coexistences are implemented among the communication stations through agreements or policy. Since one LSA spectrum band is licensed to only a limited number of LSA secondary systems, and there is a specific sharing principle between the LSA secondary systems and the LSA licensed systems, thus LSA can provide a spectrum relatively stable in time and space, that is, the available time and available geographic area of an available spectrum is relatively fixed, and the quality of service of the LSA secondary system can be guaranteed. The other spectrum sharing modes are all unlicensed spectrum sharing. Except for the secondary level shared access which can obtain a relatively stable idle spectrum from the geographic location database, the unlicensed spectrum sharing provides a spectrum with a relatively poor stability, thus communication stations are generally required to have certain abilities to implement coexistence, and the quality of service provided by the communication station is not guaranteed.

The example embodiment of the present disclosure provides a spectrum sharing method including: sending, by a communication station, a spectrum allocation parameter request message to a spectrum allocation management node, the spectrum allocation parameter request message is used by the spectrum allocation management node for performing a spectrum allocation decision, and the spectrum allocation parameter request message includes at least one or more of the following pieces of information: a spectrum sharing mode supported by the communication station, an attribute of the communication station, and a spectrum attribute requirement of the communication station; receiving, by the communication station, the spectrum allocation parameter response message sent by the spectrum allocation management node and completing the spectrum allocation according to the spectrum allocation parameter response message. The technical solution of the example embodiment of this disclosure addresses a problem of spectrum allocation failures and waste of spectrum resources resulting from the fact that a single spectrum usage rule cannot meet service requirements of a communication station, thereby improving spectrum utilization rate and success rate for spectrum allocation.

An example embodiment of the present disclosure provides a spectrum allocating method which is applied to a spectrum allocation management node, and the method includes: sending, by a spectrum allocation management node, resource management status information to a communication station, the resource management status information includes a new spectrum allocation parameter corresponding to a current operating spectrum of the communication station; receiving, by the spectrum allocation management node, a spectrum allocation completion message sent by the communication station after adjusting a spectrum allocation parameter of the current operating spectrum according to the new spectrum allocation parameter.

Correspondingly, an example embodiment of the present disclosure further provides a spectrum allocating method which is applied to a communication station, and the method includes: receiving, by a communication station, resource management status information sent from a spectrum allocation management node, the resource management status information includes a new spectrum allocation parameter corresponding to a current operating spectrum of the communication station; and sending, by the communication station, a spectrum allocation completion message to the spectrum allocation management node, after adjusting a spectrum allocation parameter of the current operating spectrum according to the new spectrum allocation parameter.

In order for technical solutions provided in this disclosure to be understood by those skilled in the art more clearly, the technical solutions provided in this disclosure are described in detail below through specific embodiments.

### First Example Embodiment

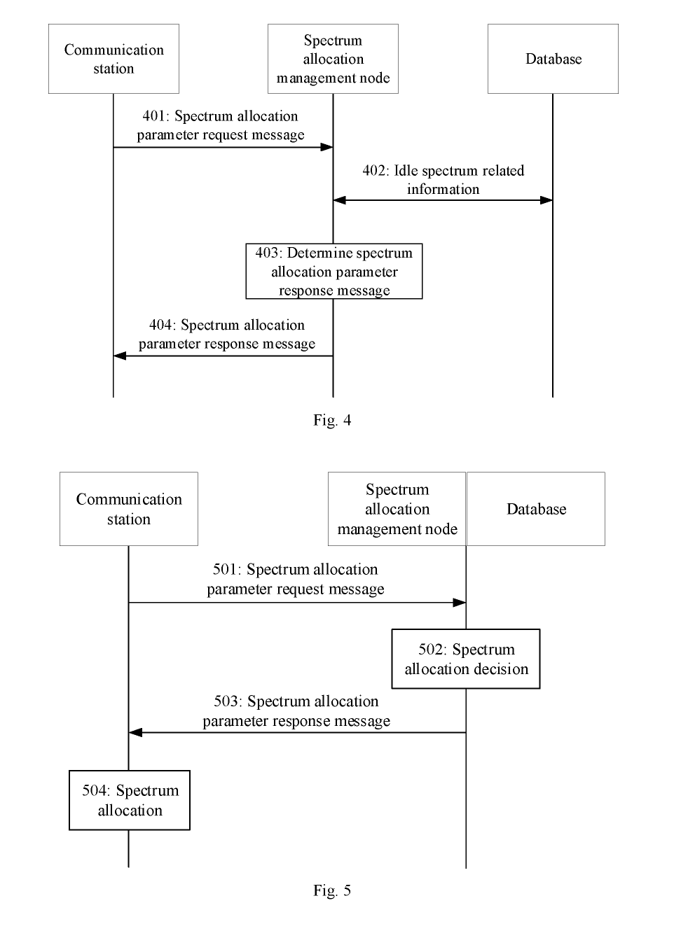

FIG. 4 is a flowchart of this embodiment. In this example embodiment, a communication station needs to provide a spectrum for services requiring low latency and high reliability (for example, services to be provided in scenarios such as traffic safety, emergency communication, intelligent industry and smart grid). These services require high spectral stability. However, the requirement for bandwidth is not high since requirement for transmission rate is not high. As shown in FIG. 4, this example embodiment includes the following steps 401 through 401.

At step 401, a communication station sends a spectrum allocation parameter request message to the spectrum allocation management node.

It is assumed that the communication station mainly provides services requiring low latency and high reliability in scenarios such as traffic safety, emergency communication, intelligent industry and smart grid, and in addition, there may be voice services requiring reliability that is not too high, and other services with low requirements are not limited herein.

The communication station determines the spectrum allocation parameter request message according to a primary service, thus contents of the spectrum allocation parameter request message sent by the communication station may be as follows.

Supported spectrum sharing modes: Co-Primary shared access, light licensing, Licensed Shared Access (LSA), secondary level shared access, and spectrum sharing in a mobile communication system.

Supported spectrum band range: 800 MHz to 6 GHz.

Supported radio access technologies: LTE (Time Division Duplexing (TDD), Frequency Division Duplexing (FDD), Global System for Mobile Communication (GSM), and Universal Mobile Telecommunications System which is referred to as UMTS, the UMTS serve as a complete 3G mobile communication technology standard.

Supported Bandwidths: LTE (5 MHz, 10 MHz, 15 MHz, 20 MHz), GSM (200 kHz), UMTS (5 MHz).

Antenna Location: (40 degrees east longitude, 50 degrees north latitude).

Device Type: Mobile Device.

Device parameters: omni-directional radiation, with the transmission power range of 30˜40 dBm.

Coexistence mode: centralized node control coexistence, distributed negotiation.

Measurement capability: capability of measuring whether a licensed system is being interfered with and the degree of the interference, capability of measuring interference relationship between communication stations.

Spectrum stability requirement: relatively high.

Bandwidth requirement: greater than or equal to 5 MHz.

At step 402, the spectrum allocation management node obtains an idle spectrum related information from a database.

Because of relatively high spectrum stability requirement of the communication station, in combination with the spectrum sharing mode supported by the communication station, the spectrum allocation management node determines to select the Co-Primary shared access with relatively high spectral stability.

In some implementations, the spectrum allocation management node provides a spectrum band supported by the communication station, a device type and antenna location information to a wireless environment map database. The wireless environment map database, according to current spectrum occupancy of each of the systems, provides a list of idle spectrums and rules for protecting other systems sharing the spectrum from being interfered with to the spectrum allocation management node, such as a restricted area corresponding to the idle spectrum, and the maximum interfering power tolerable at a reference point of other systems sharing the spectrum.

At step 403, the spectrum allocation management node determines a spectrum allocation parameter response message.

The spectrum allocation management node selects an idle spectrum with a bandwidth greater than or equal to 5 MHz, and calculates the maximum transmission power allowed for use by the communication station according to the maximum interfering power tolerable at a reference point of other systems sharing the spectrum and a propagation model from the communication station to the reference point, and determines the maximum transmission power allowable when the spectrum is used by the communication station referring to device parameters of the communication station. Additionally, the device type of the communication station is mobile, and therefore a restricted area corresponding to the spectrum needs to be given in the spectrum allocation parameter response message, and when the communication station moves out of the restricted area, it must exit the spectrum.

In this example embodiment, the spectrum allocation management node is responsible for coexistence among communication stations sharing the spectrum. That is, the spectrum allocation management node is also responsible for coexistence among communication stations in addition to being responsible for allocating spectrums for communication stations.

The contents of the spectrum allocation response message are as follows: the center frequency point is 900 MHz, the bandwidth is 5 MHz, the radio access technology is LTE TDD, the uplink and downlink subframe configuration is uplink-downlink configuration index 2 (that is, the configuration ratio of the downlink subframe to the uplink subframe is 3:1), the maximum allowable transmission power is 35 dBm, the spectrum sharing mode is the Co-Primary shared access, restricted areas corresponding to the spectrum, the coexistence mode adopted is the centralized node control coexistence, and the identifier, frequency point and bandwidth of other communication stations sharing the spectrum.

At step 404, the spectrum allocation management node sends the spectrum allocation parameter response message to the communication station.

After receiving the spectrum allocation parameter response message, the communication station completes the spectrum allocation according to the spectrum allocation parameter response message. In a case where the communication station is located beyond the restricted area corresponding to the spectrum or is about to move out of the restricted area corresponding to the spectrum due to movement of the communication station, the communication station needs to exit the current operating spectrum, re-apply for a new spectrum resource and repeat the above process. In a case where the communication station is interfered with by another communication station during the use of the spectrum, the communication station may measure the interfering relationship with the another communication station according to identifier, frequency and bandwidth information of the another communication station sharing the spectrum in the spectrum allocation response message, and determines other communication stations interfering with the communication station, and achieves coexistence with these communication stations through a centralized control mode of the spectrum allocation management node.

In this example embodiment, in a case where the spectrum allocation management node fails to obtain an appropriate idle spectrum from the wireless environment map database, the spectrum allocation management node may select another spectrum sharing mode with a lower spectrum stability, such as light licensing, LSA. The implementation process is similar to that of selecting the Co-Primary shared access, only that the database accessed may need to be changed. For example, a wireless environment map database may be accessed in a case where the light licensing is used, while a LSA database may be accessed in a case where the LSA mode is used.

### Second Example Embodiment

FIG. 5 is a flowchart of this example embodiment. In this example embodiment, a communication station generally provides a service with relatively low requirement, such as voice service and web browsing. The spectrum for transmitting such services may not meet the requirements of services with extremely high requirements for delay, reliability and transmission rate (for example, services to be provided in scenarios such as remote surgery). Therefore, when a service such as a remote surgery is to be provided, a new spectrum resource needs to be applied for. As the time for surgery is reserved in advance, the communication station may apply for a spectrum suitable for this kind of service in advance, and then may be allocated to this spectrum when the time for surgery is coming soon. In this example embodiment, the spectrum allocation management node and the database are located in one physical entity. As shown in FIG. 5, this example embodiment includes the following steps 501 through 504.

At step 501, a communication station sends a spectrum allocation parameter request message to a spectrum allocation management node.

The communication station will soon provide a service with low delay, high reliability and high requirement for rate. The communication station determines the spectrum allocation parameter request message according to the service. Therefore, the contents of the spectrum allocation parameter request message sent by the communication station are as follows.

Supported spectrum sharing modes: Licensed Shared Access (LSA), Licensed-Assisted Access (LAA), secondary level shared access, spectrum sharing in a mobile communication system, Co-Primary shared access, light licensing, Unlicensed Shared Access and Unlicensed Primary Shared Access.

Supported spectrum range: 800 MHz to 60 GHz.

Supported radio access technologies: LTE-A TDD, LTE-A FDD.

Supported Bandwidth: LTE-A (5 MHz, 10 MHz, 15 MHz, 20 MHz, 40 MHz, 1 GHz, 1.5 GHz).

Antenna Location: (40 degrees east longitude, 50 degrees north latitude).

Device Type: stationary device.

Device parameters: omni-directional radiation, with transmission power range of 30˜40 dBm.

Coexistence modes: centralized node control coexistence, distributed negotiation coexistence, mixed coexistence, and free competition coexistence.

Spectrum quality requirement: Signal to interference noise ratio being greater than 20 dB.

Spectrum stability requirement: relatively high.

Bandwidth requirement: greater than 800 MHz.

Spectrum requirements for available time: starting from 10:00 a.m. of the day, with the duration of continuous use being more than 4 hours.

At step 502, the spectrum allocation management node makes a spectrum allocation decision.

In some implementations, after receiving the spectrum allocation parameter request message sent by the communication station, the spectrum allocation management node determines to adopt the LSA according to the spectrum sharing mode supported by the communication station and the spectrum stability requirement and bandwidth of the communication station, since LSA can better ensure the service quality of the communication station, have a relatively high spectral stability, and also can provide a larger bandwidth.

In some implementations, the spectrum allocation management node obtains, from the LSA database, idle spectrum information meeting the requirements of the communication station according to the spectrum band supported by the communication station, the requirement for available time of the spectrum, the bandwidth requirement, the signal to interference noise ratio requirement, and the device type and the antenna location information. In a case where there is no spectrum in the LSA database with a continuous bandwidth that meets the requirements of the communication station, it is also acceptable that a sum of the bandwidths of multiple spectrums meets the requirements of the communication station.

At step 503, the spectrum allocation management node determines a spectrum allocation parameter response message.

Because both of the bandwidth requirement and stability requirement of communication stations are relatively high, a spectrum having a larger continuous bandwidth, a relatively lower spectrum band and meeting the requirement for available time of the communication station is given a priority to be selected. In a case where the continuous bandwidth of the idle spectrum does not meet the requirement of the communication station, multiple spectrums may be allocated to the communication station. The sum of the bandwidths of the multiple spectrums meets the bandwidth requirement of the communication station.

In this example embodiment, the spectrum allocation management node is not responsible for the coexistence among communication stations sharing the spectrum.

In this example embodiment, there is an idle spectrum with a continuous bandwidth greater than 100 MHz, therefore, the contents of the spectrum allocation response message include that: the radio access technology is LTE FDD, the uplink center frequency point is 45 GHz, the uplink bandwidth is 1 GHz, the downlink center frequency point is 28 GHz, the downlink bandwidth is 1 GHz, the maximum allowable transmission power is 35 dBm, the spectrum sharing mode is LSA, the available time for the spectrum (which may be more specific, for example, from 10:00 a.m. of the day to 17:00 of the day, 5 hours in total), the coexistence mode adopted is the centralized node control coexistence, and the identifier of the centralized management node is CN100.

At step 504, the communication station performs spectrum allocation.

After receiving the spectrum allocation parameter response message, the communication station completes the spectrum allocation according to the spectrum allocation parameter response message, and joins the network of the centralized management node, coexisting with other communication stations under the management of the centralized management node CN100.

In this example embodiment, the spectrum allocation management node may not provide the spectrum quality requirement information to the LSA database. In this case, the spectrum allocation management node needs to estimate the quality of idle spectrums from the idle spectrums provided by the LSA database, such as, the interfering power spectral density, or the interfering power or the signal to interference noise ratio, to select an idle spectrum meeting the spectrum quality requirements of the communication station, and the maximum transmission power allowed by the idle spectrum to be used by the communication station may be needed when estimating the signal to interference noise ratio.

### Third Example Embodiment

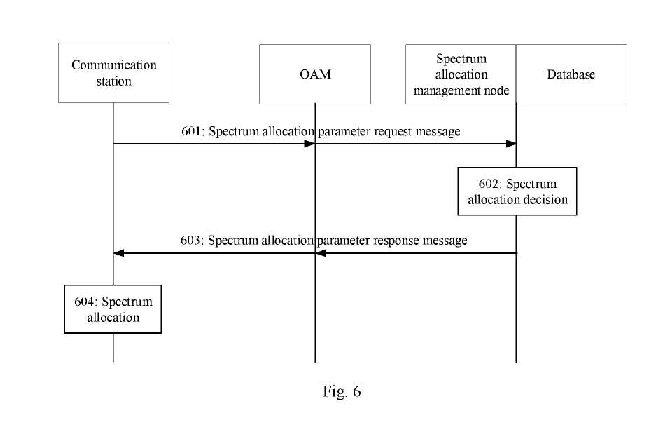

FIG. 6 is a flowchart of this example embodiment. In this example embodiment, the communication station needs to provide a spectrum for a service with relatively low requirement for transmission delay, reliability and transmission rate (such as services to be provided in scenarios such as intelligent logistics and intelligent agriculture). In the example embodiment, the spectrum allocation management node and the database are located in one physical entity. The spectrum allocation management node is an LSA controller, and the communication station communicates with the spectrum allocation management node through OAM. As shown in FIG. 6, this example embodiment includes the following steps 601 through 604.

At step 601, the communication station sends a spectrum allocation parameter request message to the spectrum allocation management node via the OAM to which the communication station belongs.

It is assumed that the communication station mainly provides a service with a relatively low requirement for transmission delay, reliability and rate in scenarios such as intelligent logistics and intelligent agriculture. Therefore, the contents of the spectrum allocation parameter request message sent by the communication station are as follows.

Supported spectrum sharing modes: Licensed-Assisted Access (LAA), secondary level shared access, spectrum sharing in a mobile communication system, Co-Primary shared access, light licensing, unlicensed shared access and unlicensed primary shared access.

Supported spectrum range: 800 MHz to 60 GHz.

Supported radio access technologies: LTE-U (TDD, FDD), LTE (TDD, FDD), GSM, UMTS (TDD, FDD).

Supported Bandwidth: LTE-U (20 MHz), LTE (5 MHz, 10 MHz, 15 MHz, 20 MHz), GSM (200 kHz), UMTS (5 MHz).

Antenna Location: (40 degrees east longitude, 50 degrees north latitude).

Device Type: stationary device.

Device parameters: Omni-directional radiation, with the maximum transmission power of 30 dBm.

Coexistence mode: centralized node control coexistence, distributed negotiation, and free competition coexistence.

Measurement Capabilities: capability of measuring whether a licensed system is being interfered with and the degree of the interference, spectrum sensing capability, and capability of measuring interference relationship among communication stations, the spectrum sensing capability specifically includes: identifying a terrestrial digital video broadcasting (DVB-T) signal and a LTE signal, the lowest detectable signal power level being −120 dBm, ranges of sensed spectrum band are 470860 MHz and 1.8˜6 GHz, the sensed bandwidth of the 470860 MHz spectrum band is 8 MHz, and the sensed bandwidths of the 1.8˜6 GHz spectrum band are 5 MHz, 10 MHz, 15 MHz and 20 MHz.

At step 602, the spectrum allocation management node makes a spectrum allocation decision, and determines a spectrum allocation parameter response message.

In some implementations, after receiving the spectrum allocation parameter request message, in a case where the spectrum allocation management node discovers that the spectrum attribute requirement of the communication station is not high, it randomly selects a spectrum sharing mode, for example, the Licensed-Assisted Access (LAA). Generally, there are existing communication systems on a spectrum shared in the LAA mode sharing the spectrum in a free competition mode, such as WiFi systems on the spectrum of 5 GHz and 2.4 GHz, thus when selecting a spectrum, a degree of idleness of the spectrum needs to be considered, and a spectrum with a high probability of being idle is preferred.

The spectrum allocation management node obtains an idle spectrum from a wireless environment map database according to the antenna location and the device type of the communication station, selects a spectrum with a high probability of being idle, and determines the spectrum allocation parameter response message. Since the communication station has the spectrum sensing capability, information related to the sensing requirement may be included in the spectrum allocation parameter response message.

The contents of the spectrum allocation parameter response message are as follows: there are three center frequency points which are 5 GHz, 4.98 GHz, and 5.02 GHz, the bandwidth is 20 MHz, the radio access technology is LTE-U TDD, the maximum allowable transmission power is 30 dBm, the spectrum sharing mode is LAA, the coexistence mode adopted is free competition coexistence, the sensing threshold is −115 dBm, the sensing period is 1 second, and the sensing duration is 2 milliseconds.

At step 603, the spectrum allocation management node sends a spectrum allocation parameter response message to the communication station via the OAM to which the communication station belongs.

At step 604, the communication station performs spectrum allocation.

After receiving the spectrum allocation parameter response message, the communication station completes the spectrum allocation according to the spectrum allocation parameter response message.

In this example embodiment, it is to be noted that, at step 602, in a case where the spectrum allocation parameter response message does not include the sensing threshold, the sensing period and the sensing duration, it is required to include information related to a silence period (for example, a period and a duration of the silence period) or a CSMA requirement, in order to coexist with other communication stations or terminals.

In this example embodiment, in a case where the communication station does not have the ability to coexist in a free competition mode, the spectrum allocation parameter response message must include information related to the silence period (for example, the period and duration, etc. of the silence period).

In this example embodiment, in a case where another spectrum sharing mode is selected, steps except for step 602 are similar, and the main difference from step 602 lies in that the content of the spectrum allocation parameter response message may be different. For example, in a case where the secondary level shared access is selected, the content of the spectrum allocation parameter response message may include, in addition to above contents, requirement for the time to exit the spectrum, the maximum time interval for accessing the database, characteristics information of the licensed system, the threshold of the interference tolerance of the licensed system, and the like, and other coexistence modes such as centralized node control coexistence and mixed coexistence may also be adopted. In a case where the spectrum sharing in a mobile communication system is selected, the content of the spectrum allocation parameter response message needs to include information about other communication stations sharing the spectrum, such as identifiers, frequency points and bandwidths etc. of other communication stations sharing the spectrum, so as to coexist with other communication stations. In a case where the unlicensed shared access is selected, the content of the spectrum allocation parameter response message is similar to that in this example embodiment, and an idle spectrum may be obtained through the wireless environment map database, or may be obtained through CSMA mechanism or spectrum sensing. In a case where the Unlicensed Primary Shared Access is selected, a spectrum licensed to a wireless access technology supported by the communication station must be selected, and then the corresponding wireless access technology is selected, and the content of the spectrum allocation parameter response message needs to include a sharing principle to be followed among communication stations, and the coexistence mode may also be different.

In this example embodiment, in a case where the communication station needs to provide a spectrum for a service with a low requirement for transmission delay and reliability but with a high requirement for transmission rate (for example, the video download scenario), the spectrum stability required by the communication station may be low as long as a larger bandwidth can be provided. Thus, a spectrum sharing mode which can provide a larger bandwidth, such as LAA or LSA, may be selected.

### Fourth Example Embodiment

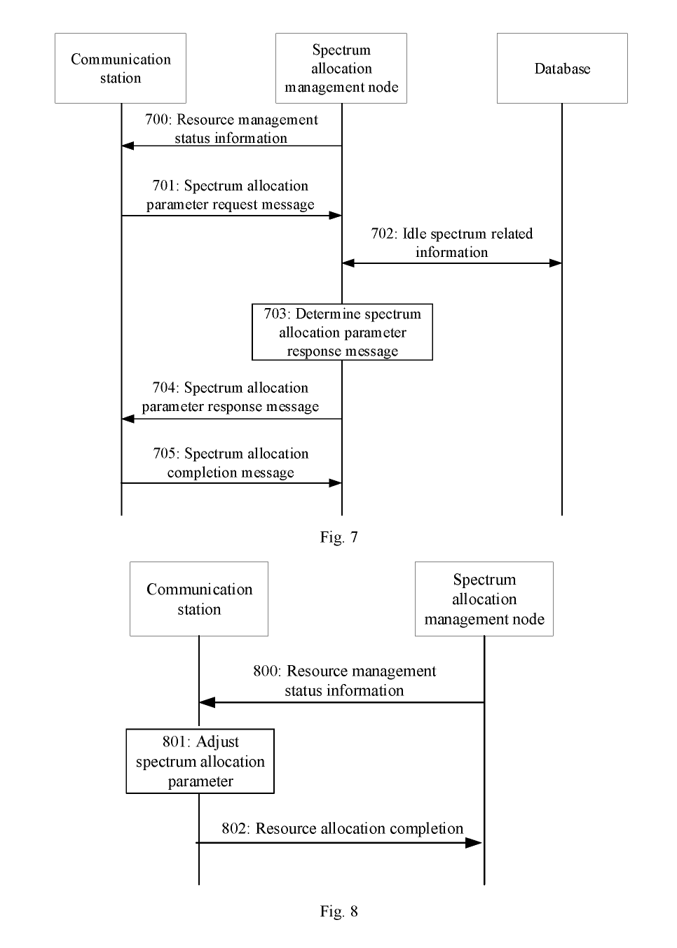

FIG. 7 is a flowchart of this example embodiment. In this example embodiment, the communication station generates a spectrum allocation parameter request message according to resource management status information sent by the spectrum allocation management node and its own spectrum requirement. As shown in FIG. 7, this example embodiment includes the following steps 700 through 705.

At step 700, the spectrum allocation management node sends the resource management status information to the communication station.

The resource management status information includes follows.

The spectrum sharing modes supported by the spectrum allocation management node are: LAA, LSA.

The spectrum band corresponding to the LAA is 5725-5825 MHz, and the spectrum band corresponding to the LSA is 2300-2400 MHz.

At step 701, the communication station sends a spectrum allocation parameter request message to the spectrum allocation management node.

The communication station generates the spectrum allocation parameter request message according to the resource management status information in combination with a main service provided currently. For example, the communication station mainly provides a service with requirement for low latency and high reliability in scenarios such as traffic safety, emergency communication, intelligent industry and smart grid and the like, and the current load is relatively heavy, and considering the spectrum sharing mode supported by the spectrum allocation management node and the corresponding spectrum band information, the contents of the spectrum allocation parameter request message sent by the communication station are as follows.

Supported spectrum sharing modes: Licensed Shared Access (LSA).

Supported spectrum band range: 2300-2350 MHz.

Supported wireless access technologies: LTE (TDD, FDD).

Supported Bandwidth: LTE (5 MHz, 10 MHz, 15 MHz, 20 MHz).

Antenna Location: (40 degrees east longitude, 50 degrees north latitude).

Device Type: stationary device.

Device parameters: omni-directional radiation, with a transmission power range of 30˜40 dBm.

Coexistence mode: centralized node control coexistence.

Measurement capabilities: capability of measuring whether a licensed system is being interfered with and the degree of the interference, capability of measuring interference relationship among communication stations.

Spectrum stability requirement: relatively high.

Bandwidth requirement: greater than or equal to 5 MHz.

At step 702, the spectrum allocation management node obtains idle spectrum related information from a database.

In some implementations, the spectrum allocation management node provides a spectrum band supported by the communication station, device type and antenna location information to a LSA database. The LSA database provides, according to current spectrum occupancy of each of the systems at the antenna location, a list of idle spectrums and rules for protecting licensed systems from being interfered with to the spectrum allocation management node, such as the maximum tolerable interfering power of the licensed systems.

At step 703: the spectrum allocation management node determines the spectrum allocation parameter response message.

The spectrum allocation management node selects an idle spectrum with a bandwidth greater than or equal to 5 MHz, and calculates the maximum transmission power allowed for use by the communication station according to the maximum interfering power tolerable at licensed systems and spectrum usage of other systems sharing the spectrum, and determines the maximum transmission power allowable when the spectrum is used by the communication station referring to device parameters of the communication station.

In this example embodiment, the spectrum allocation management node is responsible for coexistence among communication stations sharing the spectrum. That is, the spectrum allocation management node is also responsible for coexistence among communication stations in addition to being responsible for allocating spectrums for communication stations.

The contents of the spectrum idle response message are as follows: a center frequency point is 900 MHz, a bandwidth is 5 MHz, a radio access technology is LTE TDD, uplink and downlink subframe configuration is uplink-downlink configuration index 2 (for example, a configuration ratio of the downlink subframe to the uplink subframe is 3:1), a maximum allowable transmission power is 35 dBm, a spectrum sharing mode is the LSA, a maximum interfering power tolerable at a licensed system, a coexistence mode adopted is the centralized node control coexistence, and identities, frequencies and bandwidths of other communication stations sharing the spectrum.

At step 704, the spectrum allocation management node sends the spectrum allocation parameter response message to the communication station.

After receiving the spectrum allocation parameter response message, the communication station completes the spectrum allocation according to the spectrum allocation parameter response message. In a case where the communication station is interfered with by another communication station during the use of the spectrum, the communication station measures the interfering relationship with the another communication station according to identifier, frequency and bandwidth information of the another communication station sharing the spectrum in the spectrum allocation response message, and determines other communication stations interfering with the communication station, and achieves coexistence with these communication stations through a centralized control mode of the spectrum allocation management node.

At step 705, the communication station sends the spectrum allocation completion message to the spectrum allocation management node.

The communication station sends the spectrum allocation completion message to the spectrum allocation management node, notifying that it has completed the spectrum allocation successfully.

### Fifth Example Embodiment

FIG. 8 is a flowchart of this example embodiment. In this embodiment, the communication station adjusts a spectrum allocation parameter according to resource management status information sent by the spectrum allocation management node. As shown in FIG. 8, this example embodiment includes the following steps 800 through 802.

At step 800, the spectrum allocation management node sends resource management status information to the communication station.

The resource management status information includes follows.

The spectrum sharing modes supported by the spectrum allocation management node are: LAA, LSA.

The spectrum band corresponding to the LAA is 5725-5825 MHz, the spectrum band corresponding to the LSA is 2300-2400 MHz and 470-800 MHz.

New spectrum allocation parameters corresponding to the current operating spectrum 470-480 MHz of the communication station with an identifier of 001 are that: the maximum allowable transmission power is 35 dBm, the spectrum sharing mode is LSA, a restricted area corresponding to the spectrum, and the coexistence mode adopted is the centralized node control coexistence.

Here, the new spectrum allocation parameters merely contain part of the information in the original spectrum configuration parameters, and the information that is not included still refers to the information in the original spectrum allocation parameters.

At step 801, the communication station adjusts a spectrum allocation parameter according to the resource management status information.

The spectrum sharing mode corresponding to the current operating spectrum 470-480 MHz of the communication station with an identifier of 001 is the secondary level shared access, which, after being adjusted to the new spectrum allocation parameters in the spectrum management status information, still can meet the current service requirement. Therefore, the communication station adjusts a spectrum allocation parameter according to the new spectrum allocation parameters in the spectrum management status information.

At step 802, the communication station sends the spectrum allocation completion message to the spectrum allocation management node.

The communication station sends the spectrum allocation completion message to the spectrum allocation management node, notifying that it has completed the spectrum allocation successfully.

In this example embodiment, in a case where the current service requirements cannot be met after adjusting, by the communication station, to the new spectrum allocation parameters in the spectrum management status information in step 801, the communication station needs to exit the current operating spectrum of 470-480 MHz and re-apply for a new spectrum resource according to a method of one of the first through fourth example embodiments.

In all the above example embodiments, in a case where the radio access technology in the spectrum allocation parameter response message is LTE TDD but the uplink and downlink subframe configuration is not included, the communication station may determine the uplink and downlink subframe configuration for LTE TDD according to at least one of an uplink rate requirement and a coexistence requirement between the communication station and adjacent communication stations.

In all of the above example embodiments, when the coexistence mode adopted in the spectrum allocation parameter response message is centralized node control coexistence or mixed coexistence, in a case where the spectrum allocation management node is not responsible for the coexistence among communication stations sharing the spectrum, information of centralized management node is required to be provided, otherwise (e.g., in a case where the spectrum allocation management node is responsible for the coexistence among communication stations sharing the spectrum), information of the centralized management node is not required to be provided.

In all of the above example embodiments, information of the centralized management node in the spectrum allocation parameter response message may be any information that assists the communication station in determining the centralized management node, such as an IP address, an identifier and the like of the centralized management node.

In all of the above example embodiments, in a case where the communication station needs to detect whether a licensed system has re-occupied the spectrum or not by spectrum sensing during the use of an idle spectrum by the communication station, the lowest signal power level detectable by the communication station must be equal to or lower than the sensing threshold required by the licensed system when allocating a spectrum to the communication station, otherwise (e.g., in a case where the lowest signal power level detectable by the communication station is greater than the sensing threshold required by the licensed system when allocating a spectrum to the communication station), interference with the licensed system may occur because the communication station cannot detect re-occupation of the spectrum by the licensed system.

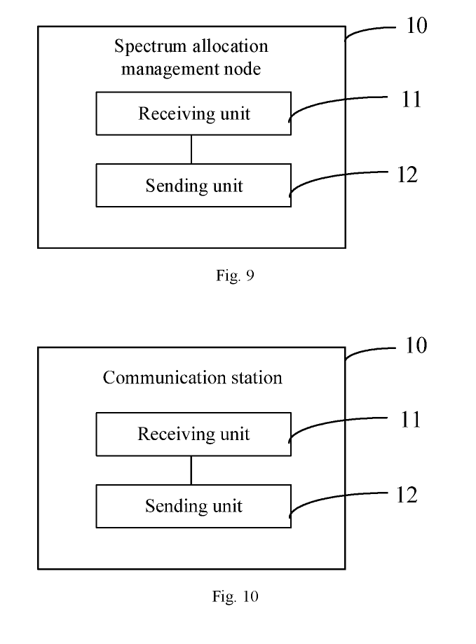

An example embodiment of the present disclosure further provides a spectrum allocation management node 10, as shown in FIG. 9, including: a receiver 11, configured to receive a spectrum allocation parameter request message sent from a communication station, and perform a spectrum allocation decision according to the spectrum allocation parameter request message, the spectrum allocation parameter request message at least includes one or more of the following pieces of information: a spectrum sharing mode supported by the communication station, an attribute of the communication station, and a spectrum attribute requirement of the communication station; and a transmitter 12, configured to send a spectrum allocation parameter response message to the communication station.

In some implementations, the transmitter is further configured to send resource management status information to the communication station, before the receiver receives the spectrum allocation parameter request message sent by the communication station; the resource management status information includes one or more of the following: a spectrum sharing mode supported by the spectrum allocation management node, a spectrum band corresponding to the spectrum sharing mode, and a new spectrum allocation parameter corresponding to a current operating spectrum of the communication station; and/or the receiver is further configured to receive a spectrum allocation completion message sent from the communication station, after the transmitter sends the spectrum allocation parameter response message; and the spectrum allocation completion message include one or more of the following: an identifier of the communication station, a spectrum allocation parameter of the communication station, an indication of whether the spectrum allocation is successful.

In some implementations, the spectrum sharing mode supported by the communication station includes one or more of the following: Licensed Shared Access (LSA), Licensed-Assisted Access (LAA), secondary level shared access, spectrum sharing within a mobile communication system, Co-Primary shared access, light licensing, Unlicensed Shared Access and Unlicensed Primary Shared Access.

The attribute of the communication station may include one or more of the following: a supported range of spectrum band, a radio access technology, a frequency point, a bandwidth, an antenna location of the communication station, a device identifier, a device type, a device parameter, a coexistence mode and measurement capability.

The spectrum attribute requirement of the communication station may include one or more of the following: spectrum quality requirement, spectrum stability requirement, bandwidth requirement, requirement for available time of the spectrum and available regional range of the spectrum.

The spectrum allocation parameter response message may include one or more of the following pieces of information: an allocated frequency point, a bandwidth, an effective time, a radio access technology, uplink and downlink subframe configuration, maximum interference power allowed at a reference point of a licensed system, maximum transmission power allowed, a spectrum sharing mode corresponding to a spectrum band, a specific requirement corresponding to the spectrum sharing mode and coexistence mode configuration.

In some implementations, performing, by the receiver, the spectrum allocation decision according to the spectrum allocation parameter request message, includes: determining, by the spectrum allocation management node, a spectrum sharing mode to be utilized according to the spectrum attribute requirement of the communication station and the spectrum sharing mode supported by the communication station; obtaining, by the spectrum allocation management node, an idle spectrum related information according to the spectrum sharing mode to be utilized and the attribute of the communication station; and determining, by the spectrum allocation management node, a spectrum allocation parameter response message according to the attribute of the communication station, the idle spectrum related information and the spectrum attribute requirement of the communication station.

This example embodiment is used to implement the above various method embodiments. For operation processes and operating principles of respective devices in this example embodiment, reference may be made to the descriptions of the above-described method embodiments, details of which are not described herein again.

With respect to the spectrum allocation management node provided in the example embodiments of the present disclosure, the spectrum allocation management node receives a spectrum allocation parameter request message sent from a communication station, and performs a spectrum allocation decision according to the spectrum allocation parameter request message, the spectrum allocation parameter request message at least includes one or more of the following pieces of information: a spectrum sharing mode supported by the communication station, an attribute of the communication station, and a spectrum attribute requirement of the communication station; and the spectrum allocation management node sends a spectrum allocation parameter response message to the communication station. The technical solution of the example embodiment of this disclosure addresses a problem of spectrum allocation failures and waste of spectrum resources resulting from the fact that a single spectrum usage rule cannot meet service requirements of a communication station, improving spectrum utilization rate and success rate for spectrum allocation.

An example embodiment of the present disclosure further provides a communication station, as shown in FIG. 10, including: a transmitter 21, configured to send a spectrum allocation parameter request message to a spectrum allocation management node, the spectrum allocation parameter request message is used by the spectrum allocation management node to make a spectrum allocation decision, and the spectrum allocation parameter request message includes one or more of the following pieces of information: a spectrum sharing mode supported by the communication station, an attribute of the communication station, and a spectrum attribute requirement of the communication station; and a receiver 22, configured to receive a spectrum allocation parameter response message sent by the spectrum allocation management node, and complete a spectrum allocation according to the spectrum allocation parameter response message.

In some implementations, the receiver is further configured to, before the transmitter sends the spectrum allocation parameter request message to the spectrum allocation management node, receive the resource management status information sent from the spectrum allocation management node, and generate the spectrum allocation parameter request message according to the resource management status information; and/or the transmitter is further configured to, after the receiver completes spectrum allocation according to the spectrum allocation parameter response message, send a spectrum allocation completion message to the spectrum allocation management node; and the spectrum allocation completion message includes one or more of the following: an identifier of the communication station, a spectrum allocation parameter of the communication station, and an indication of whether the spectrum allocation is successful.

In some implementations, the spectrum sharing mode supported by the communication station includes one or more of the following: Licensed Shared Access (LSA), Licensed-Assisted Access (LAA), secondary level shared access, spectrum sharing within a mobile communication system, Co-Primary shared access, light licensing, Unlicensed Shared Access and Unlicensed Primary Shared Access.

The attribute of the communication station may include one or more of the following: a supported range of spectrum band, a radio access technology, a frequency point, a bandwidth, an antenna location of the communication station, a device identifier, a device type, a device parameter, a coexistence mode and measurement capability.

The spectrum attribute requirement of the communication station may include one or more of the following: spectrum quality requirement, spectrum stability requirement, bandwidth requirement, requirement for available time of the spectrum and available regional range of the spectrum.

The spectrum allocation parameter response message may include one or more of the following pieces of information: an allocated frequency point, a bandwidth, an effective time, a radio access technology, uplink and downlink subframe configuration, maximum interference power allowed at a reference point of a licensed system, maximum transmission power allowed, a spectrum sharing mode corresponding to a spectrum band, a specific requirement corresponding to the spectrum sharing mode and coexistence mode configuration.

This example embodiment is used to implement the above various method embodiments. For operation processes and operating principles of respective devices in this example embodiment, reference may be made to the descriptions of the above-described method embodiments, details of which are not described herein again.

With respect to the communication station provided in the example embodiment of the present disclosure, the communication station sends a spectrum allocation parameter request message to a spectrum allocation management node, and the spectrum allocation parameter request message is used by the spectrum allocation management node to perform a spectrum allocation decision, and the spectrum allocation parameter request message includes one or more of the following pieces of information: a spectrum sharing mode supported by the communication station, an attribute of the communication station, and a spectrum attribute requirement of the communication station; the communication station receives a spectrum allocation parameter response message sent by the spectrum allocation management node, and completes spectrum allocation according to the spectrum allocation parameter response message. The technical solution of the example embodiment of this disclosure addresses a problem of spectrum allocation failures and waste of spectrum resources resulting from the fact that a single spectrum usage rule cannot meet service requirements of a communication station, improving spectrum utilization rate and success rate for spectrum allocation.

The device example embodiments described above are merely exemplary. For example, the division into respective devices is merely a division based on logical functions, and there may be other division manners in actual implementation. In addition, the devices shown or discussed may be connected to each other through some interfaces, which may be electrical, mechanical or in other forms. The respective devices may be or may not be physically separated, and may be or may not be physical devices. Some or all of the devices may be selected according to actual needs to implement aspects of these example embodiments.

Those of ordinary skill in the art may understand that all or parts of the steps of the foregoing example embodiments may be implemented by using a computer program which may be stored in a computer readable storage medium and executed on a corresponding hardware platform (such as, a system, an apparatus, an equipment, a device, etc.). When executed, the computer program includes one or a combination of the steps of a method embodiment.

In some implementations, all or part of the steps in the above example embodiments may also be implemented by using integrated circuits. These steps may be implemented by a plurality of individual integrated circuit modules corresponding to each of the steps, respectively, or a single integrated circuit module integrating all of the functions implementing these steps.

The devices/functional modules/functional units in the above example embodiments may be implemented by using a general-purpose computing apparatus, and they may be integrated on a single computing apparatus or distributed over a network formed by multiple computing apparatuses.

The devices/functional modules/functional units in the foregoing example embodiments may be stored in a computer-readable storage medium when they are implemented in the form of a software functional module and are sold or used as an independent product. The above-mentioned computer-readable storage medium may be a read-only memory, a magnetic disk, an optical disk, or the like.

### INDUSTRIAL APPLICABILITY

In technical solutions according to example embodiments of the present disclosure, the communication station sends a spectrum allocation parameter request message to a spectrum allocation management node, and the spectrum allocation parameter request message is used by the spectrum allocation management node to perform a spectrum allocation decision; the communication station receives a spectrum allocation parameter response message sent by the spectrum allocation management node, and completes spectrum allocation according to the spectrum allocation parameter response message. The technical solutions according to the example embodiments of this disclosure addresses a problem of spectrum allocation failures and waste of spectrum resources resulting from the fact that a single spectrum usage rule cannot meet service requirements of a communication station, and thus improves spectrum utilization rate and success rate for spectrum allocation.

1. A spectrum sharing method, comprising:
receiving, by a spectrum allocation management node, a spectrum allocation parameter request message sent from a communication station, and making a spectrum allocation decision according to the spectrum allocation parameter request message, wherein the spectrum allocation parameter request message comprises at least one of the following pieces of information: a spectrum sharing mode supported by the communication station, an attribute of the communication station, and a spectrum attribute requirement of the communication station; and
sending, by the spectrum allocation management node, a spectrum allocation parameter response message to the communication station.

2. The method of claim 1, further comprising:
before receiving, by the spectrum allocation management node, the spectrum allocation parameter request message sent from the communication station, sending, by the spectrum allocation management node, resource management status information to the communication station; wherein the resource management status information comprises one or more of the following: a spectrum sharing mode supported by the spectrum allocation management node, a spectrum band corresponding to the spectrum sharing mode, and a new spectrum allocation parameter corresponding to a current operating spectrum of the communication station.

3. The method of claim 1, wherein the spectrum sharing mode supported by the communication station includes one or more of the following: Licensed Shared Access (LSA), Licensed-Assisted Access (LAA), secondary level shared access, spectrum sharing within a mobile communication system, Co-Primary shared access, light licensing, Unlicensed Shared Access and Unlicensed Primary Shared Access;
the attribute of the communication station includes one or more of the following: a supported range of spectrum band, a radio access technology, a frequency point, a bandwidth, an antenna location of the communication station, a device identifier, a device type, a device parameter, a coexistence mode and measurement capability; and
the spectrum attribute requirement of the communication station includes one or more of the following: spectrum quality requirement, spectrum stability requirement, bandwidth requirement, requirement for available time of the spectrum and available regional range of the spectrum.

4. The method of claim 3, wherein the coexistence mode is a coexistence mode between the communication station and other communication stations utilizing a frequency which is adjacent to or the same as that of the communication station, and includes one or more of the following: centralized node control coexistence, distributed negotiation coexistence, mixed coexistence and free competition coexistence; and
the measurement capability includes one or more of the following: capability of measuring a licensed system being interfered with, spectrum sensing capability, and capability of measuring interference relationship among communication stations.

5. The method of claim 4, wherein the spectrum sensing capability includes one or more of the following: identifying a type of a signal occupying the spectrum, a lowest detectable level of signal power, a sensible band range of spectrum, and a sensible bandwidth.

6. The method of claim 1, wherein making, by the spectrum allocation management node, the spectrum allocation decision according to the spectrum allocation parameter request message comprises:
determining, by the spectrum allocation management node, a spectrum sharing mode to be utilized according to the spectrum attribute requirement of the communication station and the spectrum sharing mode supported by the communication station;
obtaining, by the spectrum allocation management node, an idle spectrum related information according to the spectrum sharing mode to be utilized and the attribute of the communication station; and
determining, by the spectrum allocation management node, a spectrum allocation parameter response message according to the attribute of the communication station, the idle spectrum related information and the spectrum attribute requirement of the communication station.

7. The method of claim 6, wherein obtaining the idle spectrum related information includes obtaining the idle spectrum related information from a database, wherein the database includes at least one of the following: a LSA database, a wireless environment map database and a geographic location database.

8. The method of claim 1, wherein the spectrum allocation parameter response message includes one or more of the following pieces of information: an allocated frequency point, a bandwidth, an effective time, a radio access technology, uplink and downlink subframe configuration, maximum interference power allowed at a reference point of a licensed system, maximum transmission power allowed, a spectrum sharing mode corresponding to a spectrum band, a specific requirement corresponding to the spectrum sharing mode and coexistence mode configuration.

9. The method of claim 8, wherein the specific requirement corresponding to the spectrum sharing mode includes one or more of the following: a Carrier Sense Multiple Access (CSMA) requirement, a sensing requirement, a requirement for interaction with a database and a coexistence requirement; and
the coexistence mode configuration includes a coexistence mode to be utilized by the communication station, and a related node configuration corresponding to the coexistence mode, wherein the related node configuration includes one or more of the following: information of centralized management node, and information of other communication stations that require coexistence negotiation; and the centralized management node is responsible for coexistence among communication stations sharing the spectrum.

10. The method of claim 1, further comprising: after the sending, by the spectrum allocation management node, the spectrum allocation parameter response message to the communication station, receiving, by the spectrum allocation management node, a spectrum allocation completion message sent from the communication station; wherein the spectrum allocation completion message includes one or more of the following: an identifier of the communication station, a spectrum allocation parameter of the communication station, an indication of whether the spectrum allocation is successful; wherein the spectrum allocation parameter of the communication station includes one or more of the following: an actual transmission power of the communication station, and an interference power generated at a licensed system reference point.

11. The method of claim 10, wherein in a case where the spectrum allocation completion message indicates that the spectrum allocation of the communication station is successful, and the spectrum allocation completion message includes the spectrum allocation parameter of the communication station, the spectrum allocation management node updates the spectrum allocation parameter response message to be sent to the communication station, according to the spectrum allocation parameter of the communication station, and stores the updated spectrum allocation parameter response message as an actual spectrum allocation parameter of the communication station.

12. A spectrum sharing method, comprising:
sending, by a communication station, a spectrum allocation parameter request message to a spectrum allocation management node, the spectrum allocation parameter request message being used by the spectrum allocation management node to make a spectrum allocation decision, wherein the spectrum allocation parameter request message includes one or more of the following pieces of information: a spectrum sharing mode supported by the communication station, an attribute of the communication station, and a spectrum attribute requirement of the communication station; and
receiving, by the communication station, a spectrum allocation parameter response message sent by the spectrum allocation management node, and completing spectrum allocation according to the spectrum allocation parameter response message.

13. The method of claim 12, further comprising:
before the sending, by the communication station, a spectrum allocation parameter request message to the spectrum allocation management node, receiving, by the communication station, resource management status information sent by the spectrum allocation management node; and
generating, by the communication station, the spectrum allocation parameter request message according to the resource management status information.

14. The method of claim 12, wherein the spectrum allocation parameter response message includes one or more of the following pieces of information: an allocated frequency point, a bandwidth, an effective time, a radio access technology, uplink and downlink subframe configuration, maximum interference power allowed at a reference point of a licensed system, maximum transmission power allowed, a spectrum sharing mode corresponding to a spectrum band, a specific requirement corresponding to the spectrum sharing mode and coexistence mode configuration.

15. The method of claim 12, further comprising:
after completing spectrum allocation, by the communication station, according to the spectrum allocation parameter response message, sending, by the communication station, a spectrum allocation completion message to the spectrum allocation management node, wherein the spectrum allocation completion message includes one or more of the following: an identifier of the communication station, a spectrum allocation parameter of the communication station, an indication of whether the spectrum allocation is successful; wherein the spectrum allocation parameter of the communication station includes one or more of the following: an actual transmission power of the communication station, and an interference power generated at a licensed system reference point.

16. A spectrum allocation management node, comprising:
a receiver, configured to receive a spectrum allocation parameter request message sent from a communication station, and perform a spectrum allocation decision according to the spectrum allocation parameter request message, wherein the spectrum allocation parameter request message at least includes one or more of the following pieces of information: a spectrum sharing mode supported by the communication station, an attribute of the communication station, and a spectrum attribute requirement of the communication station; and
a transmitter, configured to send a spectrum allocation parameter response message to the communication station.

17. The spectrum allocation management node of claim 16, wherein the transmitter is further configured to send resource management status information to the communication station, before the receiver receives the spectrum allocation parameter request message sent by the communication station; wherein the resource management status information includes one or more of the following: a spectrum sharing mode supported by the spectrum allocation management node, a spectrum band corresponding to the spectrum sharing mode, and a new spectrum allocation parameter corresponding to a current operating spectrum of the communication station; and/or
the receiver is further configured to receive a spectrum allocation completion message sent from the communication station, after the transmitter sends the spectrum allocation parameter response message; wherein the spectrum allocation completion message include one or more of the following: an identifier of the communication station, a spectrum allocation parameter of the communication station, an indication of whether the spectrum allocation is successful.

18. The spectrum allocation management node of claim 16, wherein performing, by the receiver, the spectrum allocation decision according to the spectrum allocation parameter request message, includes:
determining, by the spectrum allocation management node, a spectrum sharing mode to be utilized according to the spectrum attribute requirement of the communication station and the spectrum sharing mode supported by the communication station;
obtaining, by the spectrum allocation management node, an idle spectrum related information according to the spectrum sharing mode to be utilized and the attribute of the communication station; and
determining, by the spectrum allocation management node, a spectrum allocation parameter response message according to the attribute of the communication station, the idle spectrum related information and the spectrum attribute requirement of the communication station.

19. A communication station, comprising:
a transmitter, configured to send a spectrum allocation parameter request message to a spectrum allocation management node, wherein the spectrum allocation parameter request message is used by the spectrum allocation management node to make a spectrum allocation decision, wherein the spectrum allocation parameter request message at least includes one or more of the following pieces of information: a spectrum sharing mode supported by the communication station, an attribute of the communication station, and a spectrum attribute requirement of the communication station; and
a receiver, configured to receive a spectrum allocation parameter response message sent by the spectrum allocation management node, and complete spectrum allocation according to the spectrum allocation parameter response message.

20. The communication station of claim 19, wherein the receiver is further configured to, before the transmitter sends the spectrum allocation parameter request message to the spectrum allocation management node, receives the resource management status information sent from the spectrum allocation management node, and generate the spectrum allocation parameter request message according to the resource management status information; and/or
the transmitter is further configured to, after the receiver completes spectrum allocation according to the spectrum allocation parameter response message, sends a spectrum allocation completion message to the spectrum allocation management node; wherein the spectrum allocation completion message includes one or more of the following: an identifier of the communication station, a spectrum allocation parameter of the communication station, and an indication of whether the spectrum allocation is successful.
